(19) United States
(12) Patent Application Publication
(10) Pub. No.: US 2016/0285800 A1
(43) Pub. Date: Sep. 29, 2016

(54) Processing Method For Providing Health Support For User and Terminal

(71) Applicant: Huawei Technologies Co., Ltd., Shenzhen (CN)

(72) Inventors: Li Qian, Shenzhen (CN); Maosheng Huang, Shenzhen (CN)

(21) Appl. No.: 15/172,772

(22) Filed: Jun. 3, 2016

Related U.S. Application Data
(63) Continuation of application No. PCT/CN2014/085408, filed on Aug. 28, 2014.

(30) Foreign Application Priority Data
Dec. 5, 2013 (CN) 201310652949.5

(51) Int. Cl. H04L 12/58; G06F 3/0481; G06Q 50/24; G06F 19/00; H04L 29/08

(52) U.S. Cl. CPC H04L 51/046; G06F 19/3418; H04L 67/10; G06Q 50/24; G06F 3/0481

(57) ABSTRACT

A processing method for providing health support for a user and a terminal is presented. The method includes obtaining, by a second terminal, an event message of a user of a first terminal according to a first message of the first terminal, where the first message is used to reflect health information of the user of the first terminal, and the event message includes a health event of the user of the first terminal, a level of the health event, and a processing suggestion for the health event. The method further comprises parsing, by the second terminal, the event message to acquire the level of the health event; and determining, by the second terminal according to the level of the health event, a processing interface corresponding to the level of the health event, and presenting the event message to a user of the second terminal on the processing interface.

### CROSS-REFERENCE TO RELATED APPLICATIONS

This application is a continuation of International Application No. PCT/CN2014/085408, filed on Aug. 28, 2014, which claims priority to Chinese Patent Application No. 201310652949.5, filed on Dec. 5, 2013, both of which are hereby incorporated by reference in their entireties.

### TECHNICAL FIELD

Embodiments of the present disclosure relate to communications technologies, and in particular, to a processing method for providing health support for a user and a terminal.

### BACKGROUND

With the continuous development of communications technologies, more and more communications terminals bring convenient and reliable services to people's real life. Currently, some health care management systems mainly use a related terminal to establish communication with a medical device, monitor and track a health status of a user in real time using the terminal, and push a related physiological parameter of the user to a user's family member, which provides convenience for people.

In an existing health care management system, a mobile phone is connected to a medical device, so that an elderly person can measure his own related physiological parameters (for example, blood pressure, blood oxygen, electrocardiogram, blood sugar, and an amount of exercise) using a mobile phone carried by the elderly person and can check the physiological parameters using the mobile phone; and can also upload his own physiological parameters to a corresponding free service website, where the service website stores a measured historical record, and a son or a daughter may knows physical statuses of parents using the website.

However, in the prior art, simple physiological parameter information presented to a user or to a user's family member is exceedingly abstract, and lacks a direct and valuable suggestion, which is inconvenient for the user or the user's family member to directly make a real-time and effective decision and perform corresponding processing according to the information.

### SUMMARY

Embodiments of the present disclosure provide a processing method for providing health support for a user and a terminal, which are used to mitigate a prior-art problem that simple physiological parameter information presented to a user or to a user's family member is exceedingly abstract, and it is inconvenient for the user or the user's family member to directly make a real-time and effective decision and perform corresponding processing according to the information.

A first aspect of the embodiments of the present disclosure provides a processing method for providing health support for a user, including obtaining, by a second terminal, an event message of a user of a first terminal according to a first message of the first terminal, where the first message is used to reflect health information of the user of the first terminal, and the event message includes a health event of the user of the first terminal, a level of the health event, and a processing suggestion for the health event; parsing, by the second terminal, the event message to acquire the level of the health event; and determining, by the second terminal according to the level of the health event, a processing interface corresponding to the level of the health event, and presenting the event message to a user of the second terminal on the processing interface.

With reference to the first aspect, in a first possible implementation manner of the first aspect, the first message is health-related data that is of the user of the first terminal and that is collected by the first terminal, and the obtaining, by a second terminal, an event message of a first terminal according to a first message of the first terminal includes obtaining, by the second terminal, the event message using a cloud server, where the event message is obtained after the cloud server performs first processing on the received first message of the first terminal.

With reference to the first possible implementation manner of the first aspect, in a second possible implementation manner of the first aspect, the first processing is matching, by the cloud server, the first message with a health policy that is of the user of the first terminal and is preset on the cloud server, obtaining the health event of the user of the first terminal, the level of the health event, and the processing suggestion for the health event, and generating the event message according to the health event of the user of the first terminal, the level of the health event, and the processing suggestion for the health event.

With reference to the first aspect, in a third possible implementation manner of the first aspect, the first message is health-related data that is of the user of the first terminal and that is collected by the first terminal, and the obtaining, by a second terminal, an event message of a first terminal according to a first message of the first terminal further includes receiving, by the second terminal, the first message sent by the first terminal; and performing, by the second terminal, processing on the first message to acquire the event message.

With reference to the third possible implementation manner of the first aspect, in a fourth possible implementation manner of the first aspect, the performing, by the second terminal, processing on the first message to acquire the event message includes matching, by the second terminal, the first message with a health policy that is of the user of the first terminal and is preset on the second terminal, and determining the health event of the user of the first terminal, the level of the health event, and the processing suggestion for the health event; and generating, by the second terminal, the event message according to the health event of the user of the first terminal, the level of the health event, and the processing suggestion for the health event.

With reference to the first aspect, in a fifth possible implementation manner of the first aspect, the first message is the event message that is obtained after the first terminal performs processing on collected health-related data of the user of the first terminal, and the determining, by a second terminal, an event message of a first terminal according to a first message of the first terminal further includes receiving, by the second terminal, the first message sent by the first terminal.

With reference to the fifth possible implementation manner of the first aspect, in a sixth possible implementation manner of the first aspect, that the first terminal performs processing on collected health-related data of the user of the first terminal includes matching, by the first terminal, the first message with a health policy that is of the user of the first terminal and is preset on the first terminal, determining the health event of the user of the first terminal, the level of the health event, and the processing suggestion for the health event, and generating the event message according to the health event of the user of the first terminal, the level of the health event, and the processing suggestion for the health event.

With reference to the second possible implementation manner of the first aspect or the fourth possible implementation manner of the first aspect or the sixth possible implementation manner of the first aspect, in a seventh possible implementation manner of the first aspect, the health policy is generated according to a health record of the user of the first terminal.

A second aspect of the embodiments of the present disclosure provides a processing method for providing health support for a user, including acquiring, by a first terminal, a first message, where the first message includes health-related data that is of a user of the first terminal and that is collected by the first terminal, and the first message is used to reflect health information of the user of the first terminal; and sending, by the first terminal, the first message, so that a second terminal determines an event message of the user of the first terminal according to the first message, where the event message includes a health event of the user of the first terminal, a level of the health event, and a processing suggestion for the health event.

With reference to the second aspect, in a first possible implementation manner of the second aspect, the first message is the health-related data that is of the user of the first terminal and that is collected by the first terminal.

With reference to the second aspect, in a second possible implementation manner of the second aspect, the first message is the event message that is obtained after the first terminal performs first processing on the collected health-related data of the user of the first terminal.

With reference to the second aspect, in a possible implementation manner of the second aspect, the first terminal matches the first message with a health policy that is of the user of the first terminal and is preset on the first terminal, determines the health event of the user of the first terminal, the level of the health event, and the processing suggestion for the health event, and generates the event message according to the health event of the user of the first terminal, the level of the health event, and the processing suggestion for the health event.

With reference to the third possible implementation manner of the second aspect, in a fourth possible implementation manner of the second aspect, the health policy is generated according to a health record of the user of the first terminal.

A third aspect of the embodiments of the present disclosure provides a terminal, including a determining module configured to obtain an event message of a user of a first terminal according to a first message of the first terminal, where the first message is used to reflect health information of the user of the first terminal, and the event message includes a health event of the user of the first terminal, a level of the health event, and a processing suggestion for the health event; a parsing and acquiring module configured to parse the event message to acquire the level of the health event; and a display module configured to determine, according to the level of the health event, a processing interface corresponding to the level of the health event, and present the event message to a user of a second terminal on the processing interface.

With reference to the third aspect, in a first possible implementation manner of the third aspect, the first message is health-related data that is of the user of the first terminal and that is collected by the first terminal, and the determining module is configured to obtain the event message using a cloud server, where the event message is obtained after the cloud server performs first processing on the received first message of the first terminal.

With reference to the first possible implementation manner of the third aspect, in a second possible implementation manner of the third aspect, the first processing is matching, by the cloud server, the first message with a health policy that is of the user of the first terminal and is preset on the cloud server, obtaining the health event of the user of the first terminal, the level of the health event, and the processing suggestion for the health event, and generating the event message according to the health event of the user of the first terminal, the level of the health event, and the processing suggestion for the health event.

With reference to the third aspect, in a third possible implementation manner of the third aspect, the first message is health-related data that is of the user of the first terminal and that is collected by the first terminal, and the determining module is further configured to receive the first message sent by the first terminal, and perform processing on the first message to acquire the event message.

With reference to the third possible implementation manner of the third aspect, in a fourth possible implementation manner of the third aspect, the determining module is configured to match the first message with a health policy that is of the user of the first terminal and is preset on the second terminal, determine the health event of the user of the first terminal, the level of the health event, and the processing suggestion for the health event, and generate the event message according to the health event of the user of the first terminal, the level of the health event, and the processing suggestion for the health event.

With reference to the third aspect, in a fifth possible implementation manner of the third aspect, the first message is the event message that is obtained after the first terminal performs processing on collected health-related data of the user of the first terminal, and the determining module is further configured to receive the first message sent by the first terminal.

With reference to the fifth possible implementation manner of the third aspect, in a sixth possible implementation manner of the third aspect, that the first terminal performs processing on collected health-related data of the user of the first terminal includes matching, by the first terminal, the first message with a health policy that is of the user of the first terminal and is preset on the first terminal, determining the health event of the user of the first terminal, the level of the health event, and the processing suggestion for the health event, and generating the event message according to the health event of the user of the first terminal, the level of the health event, and the processing suggestion for the health event.

With reference to the second possible implementation manner of the third aspect or the fourth possible implementation manner of the third aspect or the sixth possible implementation manner of the third aspect, in a seventh possible implementation manner of the third aspect, the health policy is generated according to a health record of the user of the first terminal.

A fourth aspect of the embodiments of the present disclosure provides a terminal, including an acquiring module configured to acquire a first message, where the first message includes health-related data that is of a user of a first terminal and that is collected by the first terminal, and the first message is used to reflect health information of the user of the first terminal; and a sending module configured to send the first message, so that the second terminal determines an event message of the user of the first terminal according to the first message, where the event message includes a health event of the user of the first terminal, a level of the health event, and a processing suggestion for the health event.

With reference to the fourth aspect, in a first possible implementation manner of the fourth aspect, the first message is the health-related data that is of the user of the first terminal and that is collected by the acquiring module.

With reference to the fourth aspect, in a second possible implementation manner of the fourth aspect, the first message is the event message that is obtained after the acquiring module performs first processing on the collected health-related data of the user of the first terminal.

With reference to the second possible implementation manner of the fourth aspect, in a third possible implementation manner of the fourth aspect, the acquiring module is further configured to match the first message with a health policy that is of the user of the first terminal and is preset on the acquiring module, determine the health event of the user of the first terminal, the level of the health event, and the processing suggestion for the health event, and generate the event message according to the health event of the user of the first terminal, the level of the health event, and the processing suggestion for the health event.

With reference to the third possible implementation manner of the fourth aspect, in a fourth possible implementation manner of the fourth aspect, the health policy is generated according to a health record of the user of the first terminal.

In the processing method for providing health support for a user and a terminal according to the embodiments of the present disclosure, a second terminal determines an event message of a user of a first terminal according to a first message of the first terminal, where the event message includes a health event of the user of the first terminal, a level of the health event, and a processing suggestion for the health event; then, the second terminal parses the event message to acquire the level of the health event, determines a corresponding processing interface according to the level of the health event, and presents the event message to a user of the second terminal on the processing interface, so that the user of the second terminal performs processing on the processing interface according to the event message. According to the method provided in the embodiments of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a flowchart of Embodiment 1 of a processing method for providing health support for a user according to an embodiment of the present disclosure;

FIG. 2 is a first schematic interface diagram of a health event that is of a different level and is presented on a second terminal according to an embodiment of the present disclosure;

FIG. 3 is a second schematic interface diagram of a health event that is of a different level and is presented on a second terminal according to an embodiment of the present disclosure;

FIG. 4 is a third schematic interface diagram of a health event that is of a different level and is presented on a second terminal according to an embodiment of the present disclosure;

FIG. 5 is a flowchart of Embodiment 2 of a processing method for providing health support for a user according to an embodiment of the present disclosure;

FIG. 6 is a signaling flowchart of Embodiment 3 of a processing method for providing health support for a user according to an embodiment of the present disclosure;

FIG. 7 is a signaling flowchart of Embodiment 4 of a processing method for providing health support for a user according to an embodiment of the present disclosure;

FIG. 8 is a signaling flowchart of Embodiment 5 of a processing method for providing health support for a user according to an embodiment of the present disclosure;

FIG. 9 is a schematic structural diagram of Embodiment 1 of a terminal according to an embodiment of the present disclosure;

FIG. 10 is a schematic structural diagram of Embodiment 2 of a terminal according to an embodiment of the present disclosure;

FIG. 11 is a schematic structural diagram of Embodiment 3 of a terminal according to an embodiment of the present disclosure; and

FIG. 12 is a schematic structural diagram of Embodiment 4 of a terminal according to an embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

A terminal involved in this application, that is, user equipment, may be a wireless terminal or a wired terminal. The wireless terminal may be referred to as a device that provides a user with communication, a smart terminal or a handheld device with a radio connection function, or another processing device connected to a radio modem. The wireless terminal may communicate with one or more core networks using a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, it may be a device such as a personal communication service (PCS) phone, a cordless telephone set, a Session Initiation Protocol (SIP) phone, a wireless local loop (WLL) station, or a personal digital assistant (PDA). The wireless terminal may also be called a system, a subscriber unit, a subscriber station, a mobile station, a mobile terminal, a remote station, an access point, a remote terminal, an access terminal, a user terminal, a user agent, a user device, or user equipment.

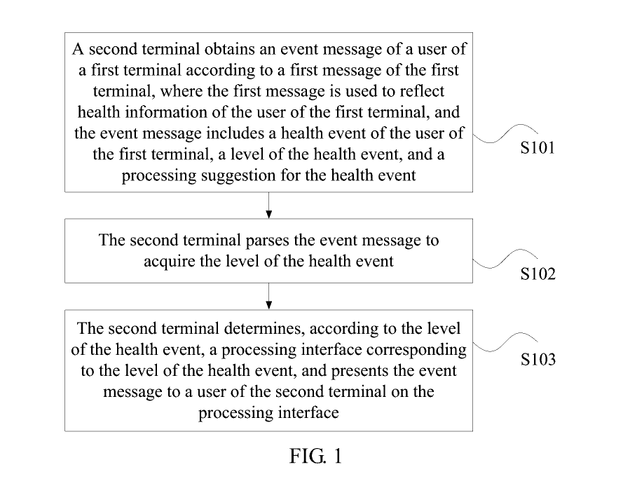

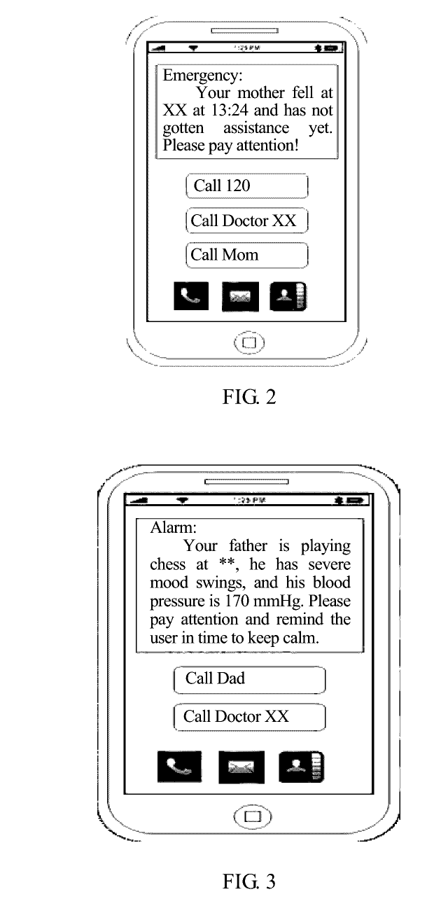

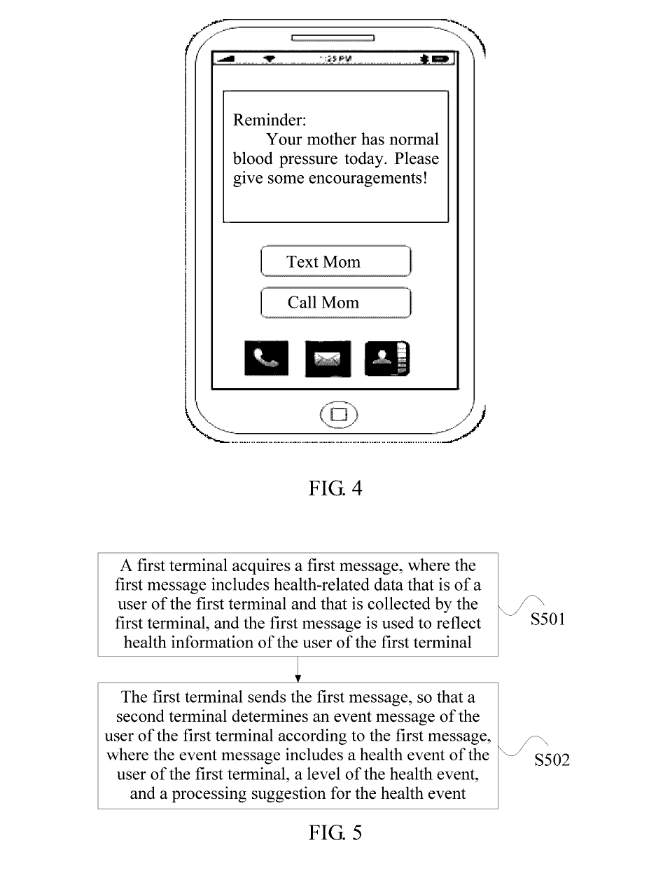

FIG. 1 is a flowchart of Embodiment 1 of a processing method for providing health support for a user according to an embodiment of the present disclosure. FIG. 2 is a first schematic interface diagram of a health event that is of a different level and is presented on a second terminal according to an embodiment of the present disclosure; FIG. 3 is a second schematic interface diagram of a health event that is of a different level and is presented on a second terminal according to an embodiment of the present disclosure; FIG. 4 is a third schematic interface diagram of a health event that is of a different level and is presented on a second terminal according to an embodiment of the present disclosure.

As shown in FIG. 1, the processing method for providing health support for a user according to this embodiment of the present disclosure includes the following steps.

S101: A second terminal obtains an event message of a user of a first terminal according to a first message of the first terminal, where the first message is used to reflect health information of the user of the first terminal, and the event message includes a health event of the user of the first terminal, a level of the health event, and a processing suggestion for the health event.

The method involved in this embodiment of the present disclosure may be applicable to a cloud computing network architecture, or may be applicable to another network architecture. Entities involved in the cloud computing network architecture may include a first terminal, a second terminal, and a cloud server, and the three are connected using a network, where the network may be a cellular network, or may be a wireless local area network. In the another network architecture, the first terminal and the second terminal are directly connected using a network, that is, there is no cloud server in the network architecture.

The first terminal in this embodiment of the present disclosure may be a wearable terminal of a user such as a smart watch, a smart band, a smart ring, or smart glasses, may be another medical monitoring device, or may be a terminal device such as a mobile phone. A main function of the first terminal is collecting and reporting health data or context environment information on a user side. The second terminal is generally a terminal device held by a son or a daughter or another family member of the user who holds the first terminal.

The first message is health data that is related to the user of the first terminal and is acquired by the first terminal, and may reflect the health information of the user of the first terminal. For example, the first message may be a physiological parameter of the user of the first terminal, may be surrounding environment information of the user of the first terminal, may be a combination of the two, or may be another message that may reflect the health information of the user of the first terminal, which is not limited in this embodiment of the present disclosure.

The second terminal determines, according to the first message, a required event message of the user of the first terminal, where the event message includes the health event of the user of the first terminal, the level of the health event, and the processing suggestion for the health event. The health event may be an event such as a fall of the user, taking strenuous exercise by the user, severe mood swings of the user, an exceedingly low blood oxygen level of the user, or constant high blood pressure of the user. The level of the health event may be emergency, alarm, reminder, normal, or the like. If the health event is a sudden emergency, for example, the user falls and needs immediate processing and first aid, a level of the event is emergency; if the health event is an event in which a physiological parameter approaches or reaches a threshold and the user needs to be given an alarm in time, a level of the event is alarm; if the health event is an event, related to health care, in which a physiological parameter slowly changes and the user needs to be given a reminder, or an event that for an existing illness, a physiological indicator parameter gets better or maintains good and the user needs to be given an encouragement, a level of the event is reminder. The processing suggestion for the health event is a processing solution that is made for a health event of the user. For example, a processing policy corresponding to the event of a fall of the user is rapidly calling a hospital for emergency treatment, a processing policy corresponding to the event of an exceedingly low blood oxygen level of the user is reminding the user in time to take corresponding medicine, and a processing policy corresponding to the event of constant high blood pressure is instructing the user to follow a healthy lifestyle, such as exercise and a healthy diet.

The event message determined by the second terminal has a particular format. For example, “Alarm: Your father is currently playing chess at XX, he has relatively severe mood swings, and his pulse exceeds XX. Please pay attention and remind the user in time to keep calm”. Herein, “alarm” is the level of the health event, “he has relatively severe mood swings, and his pulse exceeds XX” is the health event of the user, and “Please pay attention and remind the user in time to keep calm” is the processing suggestion for the health event. It should be noted that the format of the event message in this embodiment of the present disclosure may be any format, which is not limited in this embodiment of the present disclosure.

S102: The second terminal parses the event message to acquire the level of the health event.

The second terminal parses the event message, and extracts an event level field, for example, the “alarm” in the foregoing example, from the event message.

S103: The second terminal determines, according to the level of the health event, a processing interface corresponding to the level of the health event, and presents the event message to a user of the second terminal on the processing interface.

The second terminal presents different processing interfaces to the user of the second terminal according to different levels of health events, and herein, reference may be made to interface diagrams shown in FIG. 2, FIG. 3 and FIG. 4. In addition, the event message corresponding to the health event of the determined level is displayed on an interface that is presented to the user of the second terminal, so that the user of the second terminal clearly knows a health status of the user of the first terminal and a processing suggestion for the health status according to the displayed event message, and further selects a corresponding processing manner on the processing interface, such as directly calling a doctor, initiating a voice call to the user of the first terminal, or sending a message to the user of the first terminal.

In the processing method for providing health support for a user according to this embodiment of the present disclosure, a second terminal determines an event message of a user of a first terminal according to an acquired first message of the first terminal, where the event message includes a health event of the user of the first terminal, a level of the health event, and a processing suggestion for the health event; then, the second terminal parses the event message to acquire the level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 1, in a feasible implementation manner of this embodiment of the present disclosure, further, a method involved in this embodiment of the present disclosure is a specific process in which the second terminal acquires the event message using a cloud server. The method involved in this embodiment is applicable to the cloud computing network mentioned above. Optionally, the first message is health-related data that is of the user of the first terminal and that is collected by the first terminal, and S101 includes the second terminal obtains the event message using the cloud server, where the event message is obtained after the cloud server performs first processing on the received first message of the first terminal.

The first processing is matching, by the cloud server, the first message with a health policy that is of the user of the first terminal and is preset on the cloud server, obtaining the health event of the user of the first terminal, the level of the health event, and the processing suggestion for the health event, and generating the event message according to the health event of the user of the first terminal, the level of the health event, and the processing suggestion for the health event.

When the first message is the health-related data that is of the user of the first terminal and that is collected by the first terminal, the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

The first terminal collects the health-related data of the user of the first terminal using multiple types of sensors inside the first terminal, and sends the health-related data of the user of the first terminal to the cloud server in the cloud computing network; after receiving the health-related data that is of the user of the first terminal and is sent by the first terminal, the cloud server performs the first processing. The cloud server performs matching and associating on the health policy that is of the user of the first terminal and is preset on the cloud server. Optionally, the health policy may be generated according to a health record that is of the user of the first terminal and that is managed by the cloud server, and the health record may include an age, a gender, a height, a weight, a blood type, a basic health status, a past medical history, and the like of the user. It should be noted that because different users have different health records, generated health policies of the users are different.

A health policy of a user includes three parts of content: a health event, a level of the health event, and a processing suggestion for the health event. The health event refers to a specific event that is defined according to collected data such as a physiological parameter and context environment information that are reported by a user side, for example, a fall of the user, taking strenuous exercise by the user, severe mood swings of the user, an exceedingly low blood oxygen level of the user, or constant high blood pressure of the user. The level of the health event may be classified into emergency, alarm, reminder, normal, and the like. If the health event is a sudden emergency, for example, the user falls and needs immediate processing and first aid, a level of the event is emergency; if the health event is an event in which a physiological parameter approaches or reaches a threshold and the user needs to be given an alarm in time, a level of the event is alarm; if the health event is an event, related to health care, in which a physiological parameter slowly changes and the user needs to be given a reminder, or an event that for an existing illness, a physiological indicator parameter gets better or maintains good and the user needs to be given an encouragement, a level of the event is reminder. The processing suggestion for the health event is a given processing policy suggestion for a specific event. For example, a processing policy corresponding to the event of a fall of the user is rapidly calling a hospital for emergency treatment, a processing policy corresponding to the event of an exceedingly low blood oxygen level of the user is reminding the user in time to take corresponding medicine, and a processing policy corresponding to the event of constant high blood pressure is instructing the user to follow a healthy lifestyle, such as exercise and a healthy diet. For the health policy of the user of the first terminal, reference may be made to content shown in Table 1. It is assumed that the user of the first terminal has hypertension, which is shown in Table 1:

TABLE 1

| Level of a | | |
|---|---|---|
| health | | |
| event | Health event | Processing suggestion |
| Emer- | Over 15 seconds passed | Call 120/911 |
| gency | after a fall | |
| Alarm | Severe mood swings (within a | Remind a user in time |
| | time period T1, acceleration < C, | to keep calm |
| | but a pulse fluctuation | |
| | exceeds a threshold A) | |
| Reminder | Constant high blood pressure | Remind a user to pay |
| | (within a time period T2, | attention to health care: |
| | systolic blood pressure/ | a light diet, no smoking, |
| | diastolic blood pressure > B) | limited drinking, regular |
| | | exercise, and keep |
| | | psychological balance |
| Reminder | Within a relatively long time, | Encourage a user |
| | blood pressure is maintained | |
| | at a normal range | |
| | (within a time period T, C < | |
| | systolic blood pressure/ | |
| | diastolic blood pressure < B) | |
| . . . | . . . | . . . |

When the health-related data (for example, the physiological parameter and the context environment information) meets an event parameter defined in a policy, the cloud server identifies the health event corresponding to the health-related data of the user of the first terminal, and identifies the level of the health event and the processing suggestion corresponding to the health event, thereby generating the event message of the user of the first terminal, and sending the event message to the second terminal. For example, when the cloud server identifies that the health event is severe mood swings, a health policy table is searched to generate a corresponding event message: “Alarm: Your father is currently playing chess at XX, he has relatively severe mood swings, and his pulse exceeds XX. Please pay attention and remind the user in time to keep calm”.

The second terminal parses the received event message of the user of the first terminal, and extracts an event level field from the event message. An event level indicates an emergency degree of the health event, for example, the “alarm” in the foregoing example; a format of the event message in the example is: an event level+“:”+a health event+“please”+a processing suggestion. However, this embodiment of the present disclosure imposes no limitation on the format of the event message.

The second terminal presents different processing interfaces to the user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a second terminal matches a first message of a first terminal with a preset health policy on a cloud server using the cloud server to obtain an event message of a user of the first terminal; then, the second terminal parses the event message to acquire a level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 1, in another feasible implementation manner of this embodiment of the present disclosure, further, a method involved in this embodiment of the present disclosure is a process in which the second terminal generates the event message of the user of the first terminal according to the first message of the first terminal. Optionally, the first message is health-related data that is of the user of the first terminal and that is collected by the first terminal, and S101 includes the second terminal receives the first message sent by the first terminal, and performs processing on the first message to acquire the event message.

When the first message is the health-related data that is of the user of the first terminal and that is collected by the first terminal, the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

The first terminal collects the health-related data of the user of the first terminal using multiple types of sensors inside the first terminal, and sends the health-related data of the user of the first terminal to the second terminal. After receiving the health-related data that is of the user of the first terminal and is sent by the first terminal, the second terminal performs processing. The second terminal performs matching and associating on a health policy that is of the user of the first terminal and is preset on the second terminal. Optionally, the health policy may be generated according to a health record that is of the user of the first terminal and that is managed by the second terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the second terminal identifies the health event corresponding to the health-related data of the user of the first terminal, and identifies the level of the health event and the processing suggestion corresponding to the health event, thereby generating the event message of the user of the first terminal.

The second terminal parses the received event message of the user of the first terminal, extracts an event level field from the event message, and presents different processing interfaces to the user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a second terminal receives a first message sent by a first terminal, matches the first message with a preset health policy on the second terminal, determines a health event of a user of the first terminal, a level of the health event, and a processing suggestion for the health event that are corresponding to the first message, and generates an event message of the user of the first terminal according to the health event of the user of the first terminal, the level of the health event, and the processing suggestion for the health event; then, the second terminal parses the event message to acquire the level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 1, in a third feasible implementation manner of this embodiment of the present disclosure, further, a method involved in this embodiment of the present disclosure is a process in which the second terminal directly acquires the event message that is of the user of the first terminal and is sent by the first terminal. Optionally, the first message is the event message that is obtained after the first terminal performs processing on the collected health-related data of the user of the first terminal, and S101 includes the first message is received that is sent by the first terminal.

When the first terminal collects the health-related data of the user of the first terminal, the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

The first terminal performs processing after collecting the health-related data of the user of the first terminal using multiple types of sensors inside the first terminal. The first terminal performs matching and associating on a health policy that is of the user of the first terminal and is preset on the first terminal. Optionally, the health policy may be generated according to a health record that is of the user of the first terminal and that is managed by the first terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the first terminal identifies the health event corresponding to the health-related data of the user of the first terminal, and identifies the level of the health event and the processing suggestion corresponding to the health event, thereby generating the event message of the user of the first terminal, and sending the event message to the second terminal.

The second terminal parses the received event message of the user of the first terminal, extracts an event level field from the event message, and presents different processing interfaces to the user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a second terminal receives an event message sent by a first terminal, parses the event message to acquire a level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

FIG. 5 is a flowchart of Embodiment 2 of a processing method for providing health support for a user according to an embodiment of the present disclosure. As shown in FIG. 5, the method includes:

S501: A first terminal acquires a first message, where the first message includes health-related data that is of a user of the first terminal and that is collected by the first terminal, and the first message is used to reflect health information of the user of the first terminal.

The method involved in this embodiment of the present disclosure may be applicable to a cloud computing network architecture, or may be applicable to another network architecture. Entities involved in the cloud computing network architecture may include a first terminal, a second terminal, and a cloud server, and the three are connected using a network, where the network may be a cellular network, or may be a wireless local area network. In the another network architecture, the first terminal and the second terminal are directly connected using a network, that is, there is no cloud server in the network architecture.

The first terminal in this embodiment of the present disclosure may be a wearable terminal of a user such as a smart watch, a smart band, a smart ring, smart glasses, or may be another medical monitoring device. A main function of the first terminal is collecting and reporting health data, context environment information, or the like on a user side. The second terminal is generally a terminal device corresponding to a son or a daughter or another family member of the user who holds the first terminal.

Optionally, that a first terminal acquires a first message may be as follows: the first terminal collects a physiological parameter of the user of the first terminal, surrounding environment information of the user of the first terminal, and/or the like in real time, or the first terminal performs corresponding processing after collecting data such as a physiological parameter of the user of the first terminal and/or surrounding environment information of the user of the first terminal.

S502: The first terminal sends the first message, so that a second terminal determines an event message of the user of the first terminal according to the first message, where the event message includes a health event of the user of the first terminal, a level of the health event, and a processing suggestion for the health event.

The first terminal sends the first message, where the first message is the health data that is related to the user of the first terminal and is acquired by the first terminal, and may reflect the health information of the user of the first terminal. For example, the first message may be a physiological parameter of the user of the first terminal, may be surrounding environment information of the user of the first terminal, may be a combination of the two, or may be another message that may reflect the health information of the user of the first terminal, which is not limited in this embodiment of the present disclosure.

The second terminal determines, according to the first message, a required event message of the user of the first terminal, where the event message includes the health event of the user of the first terminal, the level of the health event, and the processing suggestion for the health event. The health event may be an event such as a fall of the user, taking strenuous exercise by the user, severe mood swings of the user, an exceedingly low blood oxygen level of the user, or constant high blood pressure of the user. The level of the health event may be emergency, alarm, reminder, normal, or the like. If the health event is a sudden emergency, for example, the user falls and needs immediate processing and first aid, a level of the event is emergency; if the health event is an event in which a physiological parameter approaches or reaches a threshold and the user needs to be given an alarm in time, a level of the event is alarm; if the health event is an event, related to health care, in which a physiological parameter slowly changes and the user needs to be given a reminder, or an event that for an existing illness, a physiological indicator parameter gets better or maintains good and the user needs to be given an encouragement, a level of the event is reminder. The processing suggestion for the health event is a processing solution that is made for a health event of the user. For example, a processing policy corresponding to the event of a fall of the user is rapidly calling a hospital for emergency treatment, a processing policy corresponding to the event of an exceedingly low blood oxygen level of the user is reminding the user in time to take corresponding medicine, and a processing policy corresponding to the event of constant high blood pressure is instructing the user to follow a healthy lifestyle, such as exercise and a healthy diet.

The event message determined by the second terminal has a particular format. For example, “Alarm: Your father is currently playing chess at XX, he has relatively severe mood swings, and his pulse exceeds XX. Please pay attention and remind the user in time to keep calm”. Herein, “alarm” is the level of the health event, “she has relatively severe mood swings, and her pulse exceeds XX” is the health event of the user, and “Please pay attention and remind the user in time to keep calm” is the processing suggestion for the health event. It should be noted that the format of the event message in this embodiment of the present disclosure may be any format, which is not limited in this embodiment of the present disclosure.

Then, the second terminal parses the event message, and extracts an event level field, for example, the “alarm” in the foregoing example, from the event message. The second terminal presents different processing interfaces to a user of the second terminal according to different levels of health events, and herein, reference may be made to the interface diagrams shown in FIG. 2, FIG. 3 and FIG. 4. In addition, the event message corresponding to the health event of the determined level is displayed on an interface that is presented to the user of the second terminal, so that the user of the second terminal clearly knows a health status of the user of the first terminal and a processing suggestion for the health status according to the displayed event message, and further selects a corresponding processing manner on the processing interface, such as directly calling a doctor, initiating a voice call to the user of the first terminal, or sending a message to the user of the first terminal.

In the processing method for providing health support for a user according to this embodiment of the present disclosure, a first terminal sends an acquired first message of a user of the first terminal to a second terminal, so that the second terminal determines an event message of the user of the first terminal according to the first message, parses the event message to acquire a level of the health event, determines a processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 5, in a feasible implementation manner of this embodiment of the present disclosure, a method involved in this embodiment is a process in which the first terminal uses, if the first message is the health-related data that is of the user of the first terminal and that is collected by the first terminal, a cloud server to perform first processing on the first message to obtain the event message of the user of the first terminal, and the cloud server sends the event message to the second terminal. Details may be as follows.

The first terminal collects the health-related data of the user of the first terminal using multiple types of sensors inside the first terminal, where the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

The first terminal sends the health-related data of the user of the first terminal to the cloud server in the cloud computing network; after receiving the health-related data that is of the user of the first terminal and is sent by the first terminal, the cloud server performs matching and associating on a health policy that is of the user of the first terminal and is preset on the cloud server. For the health policy, reference may be made to the foregoing embodiment, and details are not described herein again.

When the cloud server determines that the health-related data (for example, the physiological parameter and the context environment information) meets an event parameter defined in a policy, the cloud server identifies the health event corresponding to the health-related data of the user of the first terminal, and identifies the level of the health event and the processing suggestion corresponding to the health event, thereby generating the event message of the user of the first terminal, and sending the event message to the second terminal. For example, when the cloud server identifies that the health event is severe mood swings, a health policy table is searched to generate a corresponding event message: “Alarm: Your father is currently playing chess at XX, he has relatively severe mood swings, and his pulse exceeds XX. Please pay attention and remind the user in time to keep calm”.

The second terminal parses the received event message of the user of the first terminal, and extracts an event level field from the event message. An event level indicates an emergency degree of the health event, for example, the “alarm” in the foregoing example; a format of the event message in the example is: an event level+“:”+a health event+“please”+a processing suggestion. However, this embodiment of the present disclosure imposes no limitation on the format of the event message.

The second terminal presents different processing interfaces to the user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a first terminal sends collected health-related data of a user of the first terminal to a cloud server, the cloud server performs first processing on a first message to obtain an event message of the user of the first terminal, and the cloud server sends the event message to a second terminal; then, the second terminal parses the event message to acquire a level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 5, in another feasible implementation manner of this embodiment of the present disclosure, a method involved in this embodiment is a process in which the first terminal sends, if the first message is the health-related data that is of the user of the first terminal and that is collected by the first terminal, the collected health-related data of the user of the first terminal to the second terminal, and the second terminal generates the event message of the user of the first terminal after performing processing. Details may be as follows.

The first terminal collects the health-related data of the user of the first terminal using multiple types of sensors inside the first terminal, and sends the health-related data of the user of the first terminal to the second terminal. After receiving the health-related data that is of the user of the first terminal and is sent by the first terminal, the second terminal performs processing. The second terminal performs matching and associating on a health policy that is of the user of the first terminal and is preset on the second terminal. Optionally, the health policy may be generated according to a health record that is of the user of the first terminal and that is managed by the second terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the second terminal identifies the health event corresponding to the health-related data of the user of the first terminal, and identifies the level of the health event and the processing suggestion corresponding to the health event, thereby generating the event message of the user of the first terminal.

The second terminal parses the received event message of the user of the first terminal, extracts an event level field from the event message, and presents different processing interfaces to the user of the second terminal according to different levels of health events, and herein, reference may be made to the interface diagrams shown in FIG. 2 to FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface.

In the processing method for providing health support for a user according to this embodiment of the present disclosure, a first terminal sends collected health-related data of a user of the first terminal to a second terminal, and the second terminal matches the first message with a preset health policy on the second terminal, determines a health event of the user of the first terminal, a level of the health event, and a processing suggestion for the health event that are corresponding to the first message, and generates an event message of the user of the first terminal according to the health event of the user of the first terminal, the level of the health event, and the processing suggestion for the health event; then, the second terminal parses the event message to acquire the level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Based on the foregoing embodiment shown in FIG. 5, in a third feasible implementation manner of this embodiment of the present disclosure, a method involved in this embodiment is a process in which the first terminal performs processing on the collected health-related data of the user of the first terminal to generate the event message of the user of the first terminal. Details are as follows. The first terminal matches the first message with a health policy that is of the user of the first terminal and is preset on the first terminal, determines the health event of the user of the first terminal, the level of the health event, and the processing suggestion for the health event, and generates the event message according to the health event of the user of the first terminal, the level of the health event, and the processing suggestion for the health event. Details may be as follows.

The first terminal performs processing after collecting the health-related data of the user of the first terminal using multiple types of sensors inside the first terminal. The first terminal performs matching and associating on the health policy that is of the user of the first terminal and is preset on the first terminal. Optionally, the health policy may be generated according to a health record that is of the user of the first terminal and that is managed by the first terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the first terminal identifies the health event corresponding to the health-related data of the user of the first terminal, and identifies the level of the health event and the processing suggestion corresponding to the health event, thereby generating the event message of the user of the first terminal, and sending the first event message to the second terminal.

The second terminal parses the received event message of the user of the first terminal, extracts an event level field from the event message, and presents different processing interfaces to the user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button.

In the processing method for providing health support for a user according to this embodiment of the present disclosure, a first terminal generates an event message of a user of the first terminal after performing processing on collected health-related data of the user of the first terminal, and sends the event message to a second terminal, so that the second terminal parses the event message to acquire a level of the health event, determines a corresponding processing interface according to the level of the health event, and presents the event message to a user of the second terminal on the processing interface, and further, the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

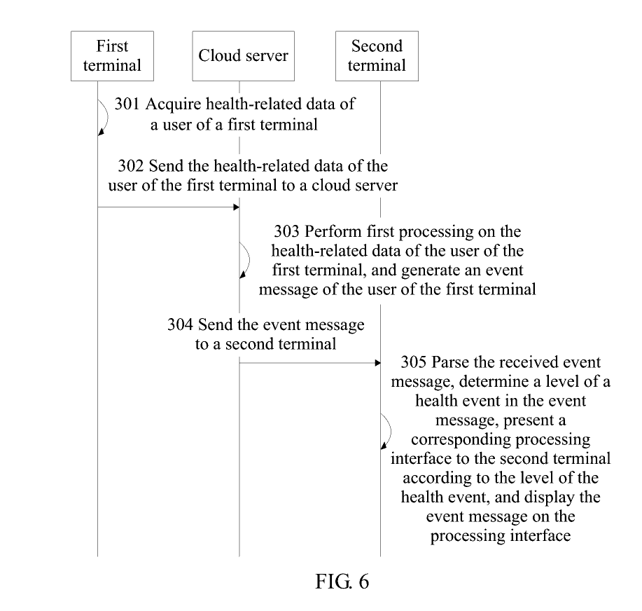

FIG. 6 is a signaling flowchart of Embodiment 3 of a processing method for providing health support for a user according to an embodiment of the present disclosure. The method involved in this embodiment is a specific process in which a first terminal sends collected health-related data of a user of the first terminal to a cloud server, and the cloud server generates an event message of the user of the first terminal after performing first processing on the health-related data of the user of the first terminal, and sends the event message to a second terminal. As shown in FIG. 6, the method includes the following steps.

S301: The first terminal acquires the health-related data of the user of the first terminal.

The first terminal collects the health-related data of the user of the first terminal using multiple types of sensors inside the first terminal, where the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

S302: The first terminal sends the health-related data of the user of the first terminal to the cloud server.

S303: The cloud server performs first processing on the health-related data of the user of the first terminal, and generates the event message of the user of the first terminal.

After receiving the health-related data that is of the user of the first terminal and is sent by the first terminal, the cloud server performs the first processing. The cloud server performs matching and associating on a health policy that is of the user of the first terminal and is preset on the cloud server. Optionally, the health policy may be generated according to a health record that is of the user of the first terminal and that is managed by the cloud server, and the health record may include an age, a gender, a height, a weight, a blood type, a basic health status, a past medical history, and the like of the user. It should be noted that because different users have different health records, generated health policies of the users are different. For content included in the health policy, reference may be made to the foregoing embodiment, and details are not described in the present disclosure again.

When the health-related data (for example, the physiological parameter and the context environment information) meets an event parameter defined in a policy, the cloud server identifies a health event corresponding to the health-related data of the user of the first terminal, and identifies a level of the health event and a processing suggestion corresponding to the health event, thereby generating the event message of the user of the first terminal, and sending the event message to the second terminal. For example, when the cloud server identifies that the health event is severe mood swings, a health policy table is searched to generate a corresponding event message: “Alarm: Your father is currently playing chess at XX, she has relatively severe mood swings, and her pulse exceeds XX. Please pay attention and remind the user in time to keep calm”.

S304: The cloud server sends the event message to the second terminal.

S305: The second terminal parses the received event message, determines a level of a health event in the event message, presents a corresponding processing interface to the second terminal according to the level of the health event, and displays the event message on the processing interface.

The second terminal parses the received event message of the user of the first terminal, and extracts an event level field from the event message. An event level indicates an emergency degree of the health event, for example, the “alarm” in the foregoing example; a format of the event message in the example is: an event level+“:”+a health event+“please”+a processing suggestion. However, this embodiment of the present disclosure imposes no limitation on the format of the event message.

The second terminal presents different processing interfaces to a user of the second terminal according to different levels of health events, and herein, reference may be made to the interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a second terminal matches, using a cloud server, health-related data that is of a user of a first terminal and is acquired by the first terminal with a preset health policy on the cloud server, thereby obtaining an event message of the user of the first terminal; then, the second terminal parses the event message to acquire a level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

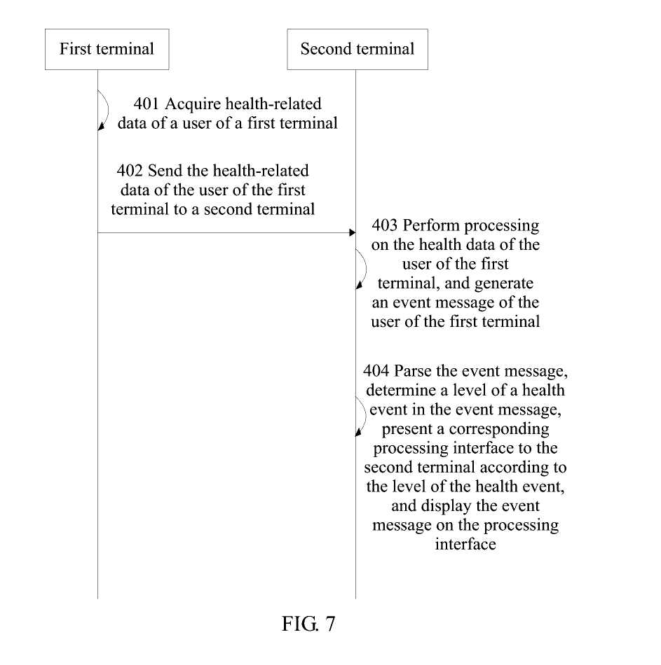

FIG. 7 is a signaling flowchart of Embodiment 4 of a processing method for providing health support for a user according to the present disclosure. The method involved in this embodiment is a specific process in which a first terminal sends collected health-related data of a user of the first terminal to a second terminal, and the second terminal generates an event message of the user of the first terminal after performing processing on the health-related data of the user of the first terminal. As shown in FIG. 7, the method includes the following steps.

S401: The first terminal acquires the health-related data of the user of the first terminal.

The first terminal collects the health-related data of the user of the first terminal using multiple types of sensors inside the first terminal, where the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

S402: The first terminal sends the health-related data of the user of the first terminal to the second terminal.

S403: The second terminal performs processing on the health data of the user of the first terminal, and generates the event message of the user of the first terminal.

The second terminal performs matching and associating on a health policy that is of the user of the first terminal and is preset on the second terminal. Optionally, the health policy may be generated according to a health record that is of the user of the first terminal and that is managed by the second terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the second terminal identifies a health event corresponding to the health-related data of the user of the first terminal, and identifies a level of the health event, and a processing suggestion corresponding to the health event, thereby generating the event message of the user of the first terminal. For example, when the second terminal identifies that the health event is severe mood swings, a health policy table is searched to generate a corresponding event message: “Alarm: Your father is currently playing chess at XX, his has relatively severe mood swings, and the pulse exceeds XX. Please pay attention and remind the user in time to keep calm”.

S404: The second terminal parses the event message, determines a level of a health event in the event message, presents a corresponding processing interface to the second terminal according to the level of the health event, and displays the event message on the processing interface.

The second terminal parses the received event message of the user of the first terminal, extracts an event level field from the event message, and presents different processing interfaces to a user of the second terminal according to different levels of health events, and herein, reference may be made to the processing interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a second terminal receives health-related data that is of a user of a first terminal and is sent by the first terminal, matches the health-related data with a preset health policy on the second terminal, determines a health event of the user of the first terminal, a level of the health event, and a processing suggestion for the health event that are corresponding to the health-related data, and generates an event message of the user of the first terminal according to the health event of the user of the first terminal, the level of the health event, and the processing suggestion for the health event; then, the second terminal parses the event message to acquire the level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

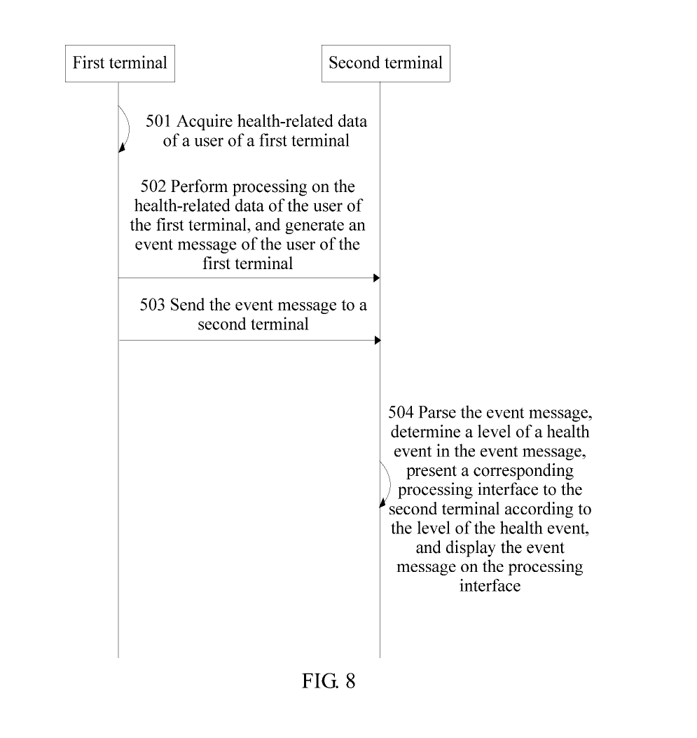

FIG. 8 is a signaling flowchart of Embodiment 5 of a processing method for providing health support for a user according to the present disclosure. The method involved in this embodiment is a specific process in which a first terminal generates an event message of a user of the first terminal after performing processing on collected health-related data of the user of the first terminal, and sends the event message to a second terminal. As shown in FIG. 8, the method includes the following steps.

S501: The first terminal acquires the health-related data of the user of the first terminal.

The first terminal collects the health-related data of the user of the first terminal using multiple types of sensors inside the first terminal, where the health-related data herein may be a physiological parameter of the user of the first terminal, surrounding context environment information of the user of the first terminal, and/or the like. The physiological parameter of the user of the first terminal herein may include a pulse, blood oxygen, blood pressure, body temperature, and the like; the context environment information may include time, a position, a schedule or a habit of the user, an activity status of the user, temperature, humidity, illumination, and atmospheric pressure that are of an external environment, and the like. The activity status of the user may be collected using an acceleration sensor inside the first terminal, and a motion speed increase change of the user is obtained by means of monitoring, thereby analyzing the activity status of the user through calculation, that is, determining whether the activity status of the user is walking, running, or taking a ride. In addition, a camera of the first terminal may be used to snap a current scene, a current activity, and the like of the user.

S502: The first terminal performs processing on the health-related data of the user of the first terminal, and generates the event message of the user of the first terminal.

S503: The first terminal sends the event message to the second terminal.

The first terminal performs matching and associating on a health policy that is of the user of the first terminal and is preset on the first terminal. Optionally, the health policy may be generated according to a health record that is of the user of the first terminal and that is managed by the first terminal, and the health record may include an age, a gender, a height, a weight, a blood type, a basic health status, a past medical history, and the like of the user. It should be noted that because different users have different health records, generated health policies of the users are different. For content of the health policy, reference may be made to the content of the foregoing embodiment, and details are not described herein again.

When the health-related data (for example, the physiological parameter and the context environment information) meets an event parameter defined in a policy in Table 1, the first terminal identifies a health event corresponding to the health-related data of the user of the first terminal, and identifies a level of the health event and a processing suggestion corresponding to the health event, thereby generating the event message of the user of the first terminal, and sending the first event message to the second terminal.

S504: The second terminal parses the event message, determines a level of a health event in the event message, presents a corresponding processing interface to the second terminal according to the level of the health event, and displays the event message on the processing interface.

The second terminal parses the received event message of the user of the first terminal, extracts an event level field from the event message, and presents different processing interfaces to a user of the second terminal according to different levels of health events, and herein, reference may be made to the processing interface diagrams shown in FIG. 2, FIG. 3 and FIG. 4. In addition, the event message corresponding to the health event of the determined level is displayed on the interface that is presented to the user of the second terminal, so that the user of the second terminal clearly knows a health status of the user of the first terminal and a processing suggestion for the health status according to the displayed event message, and further selects a corresponding processing manner on the processing interface, where the processing interface includes content of the event message and a preset corresponding processing decision button. For example, in FIG. 2, when an extracted event level is emergency, a button for directly calling a hospital is presented on a processing interface, for example, Call 120/911 or another preset emergency number; in FIG. 3, when an extracted event level is alarm, a button for directly calling a first user or another assistance telephone number is presented on a processing interface; in FIG. 4, when an extracted event level is reminder, a button for sending a short message service message to a first user or calling a first user is presented on a processing interface.

In the processing method for providing health support for a user according to this embodiment of the present disclosure, a first terminal generates an event message of a user of the first terminal after performing processing on health-related data that is of the user of the first terminal and is acquired by the first terminal, and sends the event message to a second terminal; the second terminal parses the event message to acquire a level of the health event, determines a corresponding processing interface according to the level of the health event, and presents the event message to a user of the second terminal on the processing interface, so that the user of the second terminal performs processing on the processing interface according to the event message. According to the method provided in this embodiment of the present disclosure, the user of the second terminal can understand a current health status of the user of the first terminal more accurately, and acquire a processing suggestion in time; in addition, the second terminal presents, according to a level of a health event, a different processing interface related to an event message, which can assist the user of the second terminal in performing real-time processing on a health emergency.

Persons of ordinary skill in the art may understand that all or some of the steps of the foregoing method embodiments may be implemented by a program instructing relevant hardware. The program may be stored in a computer-readable storage medium. When the program runs, the steps of the foregoing method embodiments are performed. The storage medium mentioned above includes: any medium that can store program code, such as a read-only memory (ROM), a random access memory (RAM), a magnetic disk, or an optical disc.

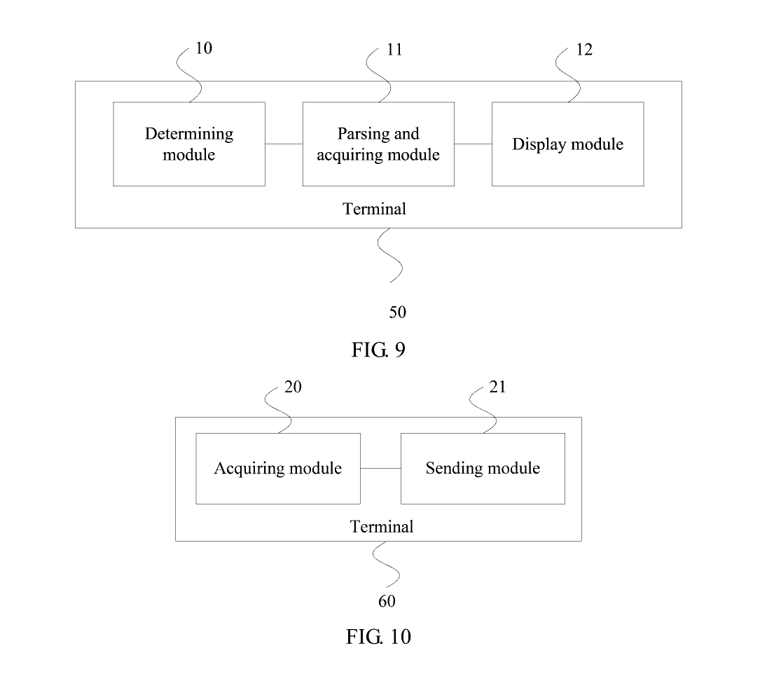

FIG. 9 is a schematic structural diagram of Embodiment 1 of a terminal according to the present disclosure. The terminal may be the second terminal in the foregoing method embodiment. As shown in FIG. 9, the terminal 50 includes a determining module 10 configured to obtain an event message of a user of a first terminal according to a first message of the first terminal, where the first message is used to reflect health information of the user of the first terminal, and the event message includes a health event of the user of the first terminal, a level of the health event, and a processing suggestion for the health event; a parsing and acquiring module 11 configured to parse the event message to acquire the level of the health event; and a display module 12 configured to: determine, according to the level of the health event, a processing interface corresponding to the level of the health event, and present the event message to a user of the second terminal on the processing interface.

The terminal provided in this embodiment of the present disclosure may execute the foregoing method embodiment. Implementation principles and technical effects of this embodiment are similar to those of the method embodiment, and details are not described herein again.

Optionally, the first message is health-related data that is of the user of the first terminal and that is collected by the first terminal. Based on the foregoing embodiment shown in FIG. 9, further, the determining module 10 is configured to obtain the event message using a cloud server, where the event message is obtained after the cloud server performs first processing on the received first message of the first terminal. The first processing is matching, by the cloud server, the first message with a health policy that is of the user of the first terminal and is preset on the cloud server, determining the health event of the user of the first terminal, the level of the health event, and the processing suggestion for the health event, and generating the event message according to the health event of the user of the first terminal, the level of the health event, and the processing suggestion for the health event.

The terminal provided in this embodiment of the present disclosure may execute the foregoing method embodiment. Implementation principles and technical effects thereof are similar, and details are not described herein again.

Optionally, the first message is health-related data that is of the user of the first terminal and that is collected by the first terminal. Based on the foregoing embodiment shown in FIG. 9, further, the determining module 10 is further configured to receive the first message sent by the first terminal, and perform processing on the first message to acquire the event message. The determining module 10 is configured to match the first message with a health policy that is of the user of the first terminal and is preset on the second terminal, determine the health event of the user of the first terminal, the level of the health event, and the processing suggestion for the health event, and generate the event message according to the health event of the user of the first terminal, the level of the health event, and the processing suggestion for the health event.

The terminal provided in this embodiment of the present disclosure may execute the foregoing method embodiment. Implementation principles and technical effects thereof are similar, and details are not described herein again.

Optionally, the first message is the event message that is obtained after the first terminal performs processing on collected health-related data of the user of the first terminal. Based on the foregoing embodiment shown in FIG. 9, further, the determining module 10 is further configured to receive the first message sent by the first terminal. That the first terminal performs processing on collected health-related data of the user of the first terminal includes: matching, by the first terminal, the first message with a health policy that is of the user of the first terminal and is preset on the first terminal, determining the health event of the user of the first terminal, the level of the health event, and the processing suggestion for the health event, and generating the event message according to the health event of the user of the first terminal, the level of the health event, and the processing suggestion for the health event.

The terminal provided in this embodiment of the present disclosure may execute the foregoing method embodiment. Implementation principles and technical effects thereof are similar, and details are not described herein again.

FIG. 10 is a schematic structural diagram of Embodiment 2 of a terminal according to the present disclosure. The terminal may be the first terminal in the foregoing method embodiment. As shown in FIG. 10, the terminal 60 includes an acquiring module 20 configured to acquire a first message, where the first message includes health-related data that is of a user of the first terminal and that is collected by the first terminal, and the first message is used to reflect health information of the user of the first terminal; and a sending module 21 configured to send the first message, so that a second terminal determines an event message of the user of the first terminal according to the first message, where the event message includes a health event of the user of the first terminal, a level of the health event, and a processing suggestion for the health event.

The terminal provided in this embodiment of the present disclosure may execute the foregoing method embodiment. Implementation principles and technical effects thereof are similar, and details are not described herein again.

Optionally, the acquiring module 20 is further configured to match the first message with a health policy that is of the user of the first terminal and is preset on the acquiring module 20, determine the health event of the user of the first terminal, the level of the health event, and the processing suggestion for the health event, and generate the event message according to the health event of the user of the first terminal, the level of the health event, and the processing suggestion for the health event.

The terminal provided in this embodiment of the present disclosure may execute the foregoing method embodiment. Implementation principles and technical effects thereof are similar, and details are not described herein again.

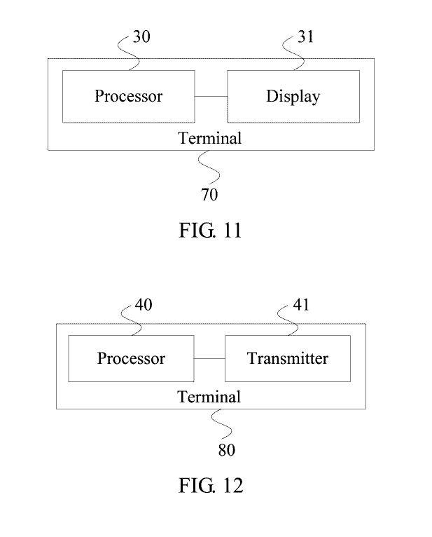

FIG. 11 is a schematic structural diagram of Embodiment 3 of a terminal according to the present disclosure. The terminal may be the second terminal in the foregoing method embodiment. As shown in FIG. 11, the terminal 70 includes a processor 30 configured to obtain an event message of a user of a first terminal according to a first message of the first terminal, where the first message is used to reflect health information of the user of the first terminal, and the event message includes a health event of the user of the first terminal, a level of the health event, and a processing suggestion for the health event; further configured to parse the event message to acquire the level of the health event; and a display 31 configured to determine, according to the level of the health event, a processing interface corresponding to the level of the health event, and present the event message to a user of the second terminal on the processing interface.

Optionally, the first message is health-related data that is of the user of the first terminal and that is collected by the first terminal, and the processor 30 is further configured to obtain the event message using a cloud server, where the event message is obtained after the cloud server performs first processing on the received first message of the first terminal. The first processing is matching, by the cloud server, the first message with a health policy that is of the user of the first terminal and is preset on the cloud server, determining the health event of the user of the first terminal, the level of the health event, and the processing suggestion for the health event, and generating the event message according to the health event of the user of the first terminal, the level of the health event, and the processing suggestion for the health event.

Optionally, the first message is health-related data that is of the user of the first terminal and that is collected by the first terminal, and the processor 30 is further configured to receive the first message sent by the first terminal, and perform processing on the first message to acquire the event message; and the processor 30 is configured to match the first message with a health policy that is of the user of the first terminal and is preset on the second terminal, determine the health event of the user of the first terminal, the level of the health event, and the processing suggestion for the health event, and generate the event message according to the health event of the user of the first terminal, the level of the health event, and the processing suggestion for the health event.

Optionally, the first message is the event message that is obtained after the first terminal performs processing on collected health-related data of the user of the first terminal, and the processor 30 is further configured to receive the first message sent by the first terminal.

The terminal provided in this embodiment of the present disclosure may execute the foregoing method embodiment. Implementation principles and technical effects thereof are similar, and details are not described herein again.

FIG. 12 is a schematic structural diagram of Embodiment 3 of a terminal according to the present disclosure. The terminal may be the first terminal in the foregoing method embodiment. As shown in FIG. 12, the terminal 80 includes a processor 40 configured to acquire a first message, where the first message includes health-related data that is of a user of the first terminal and that is collected by the first terminal, and the first message is used to reflect health information of the user of the first terminal; and a transmitter 41 configured to send the first message, so that a second terminal determines an event message of the user of the first terminal according to the first message, where the event message includes a health event of the user of the first terminal, a level of the health event, and a processing suggestion for the health event.

Optionally, the processor 40 is further configured to match the first message with a health policy that is of the user of the first terminal and is preset on the processor 40, determine the health event of the user of the first terminal, the level of the health event, and the processing suggestion for the health event, and generate the event message according to the health event of the user of the first terminal, the level of the health event, and the processing suggestion for the health event.

The terminal provided in this embodiment of the present disclosure may execute the foregoing method embodiment. Implementation principles and technical effects thereof are similar, and details are not described herein again.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A processing method for providing health support for a user, comprising:
obtaining, by a second terminal, an event message of a user of a first terminal according to a first message of the first terminal, wherein the first message is used to reflect health information of the user of the first terminal, and the event message comprises a health event of the user of the first terminal, a level of the health event, and a processing suggestion for the health event;
parsing, by the second terminal, the event message to acquire the level of the health event; and
determining, by the second terminal according to the level of the health event, a processing interface corresponding to the level of the health event, and presenting the event message to a user of the second terminal on the processing interface.

2. The method according to claim 1, wherein the first message is health-related data that is of the user of the first terminal and that is collected by the first terminal, and wherein obtaining, by the second terminal, the event message of the user of the first terminal according to the first message of the first terminal comprises obtaining, by the second terminal, the event message using a cloud server, wherein the event message is obtained after the cloud server performs first processing on the received first message of the first terminal.

3. The method according to claim 2, wherein the first processing is matching, by the cloud server, the first message with a health policy that is of the user of the first terminal and is preset on the cloud server, obtaining the health event of the user of the first terminal, the level of the health event, and the processing suggestion for the health event, and generating the event message according to the health event of the user of the first terminal, the level of the health event, and the processing suggestion for the health event.

4. The method according to claim 1, wherein the first message is health-related data that is of the user of the first terminal and that is collected by the first terminal, and wherein obtaining the event message of the user of the first terminal according to the first message of the first terminal further comprises:
receiving, by the second terminal, the first message sent by the first terminal; and
performing, by the second terminal, processing on the first message to acquire the event message.

5. The method according to claim 4, wherein performing, by the second terminal, processing on the first message to acquire the event message comprises:
matching, by the second terminal, the first message with a health policy that is of the user of the first terminal and is preset on the second terminal, and determining the health event of the user of the first terminal, the level of the health event, and the processing suggestion for the health event; and
generating, by the second terminal, the event message according to the health event of the user of the first terminal, the level of the health event, and the processing suggestion for the health event.

6. The method according to claim 1, wherein the first message is the event message that is obtained after the first terminal performs processing on collected health-related data of the user of the first terminal, and wherein determining, by the second terminal, the event message of the user of the first terminal according to the first message of the first terminal further comprises receiving, by the second terminal, the first message sent by the first terminal.

7. The method according to claim 6, wherein that the first terminal performs processing on collected health-related data of the user of the first terminal comprises:
matching, by the first terminal, the first message with a health policy that is of the user of the first terminal and is preset on the first terminal;
determining the health event of the user of the first terminal, the level of the health event, and the processing suggestion for the health event; and
generating the event message according to the health event of the user of the first terminal, the level of the health event, and the processing suggestion for the health event.

8. A processing method for providing health support for a user, comprising:
acquiring, by a first terminal, a first message, wherein the first message comprises health-related data that is of a user of the first terminal and that is collected by the first terminal, and wherein the first message is used to reflect health information of the user of the first terminal; and
sending, by the first terminal, the first message, such that a second terminal determines an event message of the user of the first terminal according to the first message, wherein the event message comprises a health event of the user of the first terminal, a level of the health event, and a processing suggestion for the health event.

9. The method according to claim 8, wherein the first terminal:
matches the first message with a health policy that is of the user of the first terminal and is preset on the first terminal;
determines the health event of the user of the first terminal, the level of the health event, and the processing suggestion for the health event; and
generates the event message according to the health event of the user of the first terminal, the level of the health event, and the processing suggestion for the health event.

10. A terminal, comprising:
a processor configured to obtain an event message of a user of a second device according to a first message of the second device, wherein the first message is used to reflect health information of the user, and wherein the event message comprises a health event of the user, a level of the health event, and a processing suggestion for the health event; and further configured to parse the event message to acquire the level of the health event; and
a display monitor configured to determine, according to the level of the health event, a processing interface corresponding to the level of the health event, and display the event message on the processing interface.

11. The terminal according to claim 10, wherein the first message is health-related data that is of the user and that is collected by the second device, wherein the processor is configured to obtain the event message from a cloud server, and wherein the event message is obtained after the cloud server performs first processing on the received first message.

12. The terminal according to claim 11, wherein the first processing comprises:
matching, by the cloud server, the first message with a preset health policy;
obtaining the health event of the user, the level of the health event, and the processing suggestion for the health event; and
generating the event message according to the health event of the user of, the level of the health event, and the processing suggestion for the health event.

13. The terminal according to claim 10, wherein the processor is configured to:
match the first message with a health policy;
determine the health event of the user, the level of the health event, and the processing suggestion for the health event; and
generate the event message according to the health event of the user, the level of the health event, and the processing suggestion for the health event.

14. The terminal according to claim 10, wherein the processor is further configured to:
match the first message with a preset health policy of the user;
determine the health event of the user, the level of the health event, and the processing suggestion for the health event; and
generate the event message according to the health event of the user of a first terminal, the level of the health event, and the processes suggestion for the health event.

15. A terminal, comprising:
a processor configured to acquire a first message, wherein the first message comprises health-related data that is of a first user and that is collected by a first terminal, and the first message is used to reflect health information of the first user of the first terminal; and
a transmitter configured to send the first message to a second device, so that the second device determines an event message of a second user according to the first message, wherein the event message comprises a health event of the second user, a level of the health event, and a processing suggestion for the health event.

16. The terminal according to claim 15, wherein the processor is further configured to:
match the first message with a health policy that is of the user and is preset;
determine the health event of the user, the level of the health event, and the processing suggestion for the health event; and
generate the event message according to the health event of the user, the level of the health event, and the processing suggestion for the health event.
